(19) United States
(12) Patent Application Publication
(10) Pub. No.: US 2015/0153954 A1
(43) Pub. Date: Jun. 4, 2015

(54) WIRELESS HDD WITH INTEGRATED STORAGE CONTROLLER AND WIRELESS PROCESSING

(71) Applicant: Marvell World Trade Ltd., St. Michael (BB)

(72) Inventors: Sehat Sutardja, Los Altos Hills, CA (US); Son Hong Ho, Los Altos, CA (US)

(21) Appl. No.: 14/405,725

(22) PCT Filed: Jun. 4, 2013
(86) PCT No.: PCT/US13/44018

§ 371 Date: Dec. 4, 2014

Related U.S. Application Data
(60) Provisional application No. 61/655,294, filed on Jun. 4, 2012.

(51) Int. Cl. G06F 3/06; H04W 88/02

(52) U.S. Cl. CPC G06F 3/0604; G06F 3/064; G06F 3/0674; H04W 88/02

(57) ABSTRACT

A storage device includes a wireless interface and a processor. The wireless interface is configured to receive wireless data from a device external to the storage device. The wireless data includes at least one data packet configured according to a wireless communication protocol. The processor is configured to receive the wireless data including the at least one data packet from the wireless interface, generate a storage device data package including the wireless data, store, in a storage region of the storage device, the storage device data package including the wireless data, retrieve the storage device data package from the storage region, recover the wireless data from the storage device data package, and provide the wireless data to the wireless interface for transmission to the device external to the storage device.

### CROSS-REFERENCE TO RELATED APPLICATIONS

This application claims the benefit of U.S. Provisional Application No. 61/655,294, filed on Jun. 4, 2012. The entire disclosures of the applications referenced above are incorporated herein by reference.

### FIELD

The present disclosure relates to wireless storage devices including hard disk drives (HDDs), and more particularly to systems and methods for incorporating control of wireless data processing in a storage controller of a wireless storage device.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Electronic devices may include a data storage device such as a hard disk drive (HDD). Alternatively or additionally, the electronic devices may interface with remote storage, including, but not limited to, cloud storage and/or a separate data storage device (e.g., a mobile HDD). Electronic devices implement a wide variety of applications that access the remote storage for storing data and/or to perform respective functions using data already stored on the storage device. For example, the remote storage may store data such as multimedia content (e.g., music, video and photo content, and/or e-books). An electronic device accesses the multimedia content in the remote storage to present the multimedia content to a user.

In addition to multimedia content, the remote storage may store other types of data including, but not limited to, games and other program files. The remote storage may also store private data such as financial information, personal contact lists, passwords, and/or document and Internet browsing history. Accordingly, a user may prefer a remote storage device such as a mobile HDD over cloud storage for storing private data. Further, connection to cloud storage may be limited or interrupted, interfering with access to the data stored in cloud storage.

FIG. 1 shows an example HDD 10 that communicates with a wireless module 14. The HDD 10 includes an HDD PCB 18 and a hard disk assembly (HDA) 22. The PCB 18 includes a hard disk controller (HDC) module 26 that controls components of the HDA 22 and communicates with an external device (e.g., an electronic device such as a smartphone or a tablet computer; not shown), via the wireless module 14, using a processor (e.g., CPU 30).

The wireless module 14 communicates with the external device by using an antenna 34 to transmit and receive wireless data packets (e.g., WiFi data packets). A wireless interface 38 communicates the data packets to an application processor 42. The application processor 42 converts the data packets to, for example, USB data, and provides the USB data to a USB to SATA module 46. The USB to SATA module 46 converts the USB data to SATA data. The wireless module 14 provides the SATA data to (and receives SATA data from) the HDD 10 via respective SATA connectors 50 and 54. The CPU 30 may process the SATA data, including encoding, decoding, filtering, and/or formatting. For example only, the CPU 30 formats the SATA data as HDD data suitable for storage in the HDA 22.

### SUMMARY

A storage device includes a wireless interface and a processor. The wireless interface is configured to receive wireless data from a device external to the storage device. The wireless data includes at least one data packet configured according to a wireless communication protocol. The processor is configured to receive the wireless data including the at least one data packet from the wireless interface, generate a storage device data package including the wireless data, store, in a storage region of the storage device, the storage device data package including the wireless data, retrieve the storage device data package from the storage region, recover the wireless data from the storage device data package, and provide the wireless data to the wireless interface for transmission to the device external to the storage device.

A method of operating a storage device includes receiving, using a wireless interface located in the storage device, wireless data from a device external to the storage device, wherein the wireless data includes at least one data packet configured according to a wireless communication protocol, and, using a processor located in the storage device, receiving the wireless data including the at least one data packet from the wireless interface, generating a storage device data package including the wireless data, storing, in a storage region of the storage device, the storage device data package including the wireless data, retrieving the storage device data package from the storage region, recovering the wireless data from the storage device data package, and providing the wireless data to the wireless interface for transmission to the device external to the storage device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example hard disk drive and an example wireless module according to the prior art.

FIG. 2 is a functional block diagram of an example wireless mobile hard disk drive according to the principles of the present disclosure.

FIG. 3 is another functional block diagram of an example wireless mobile hard disk drive according to the principles of the present disclosure.

FIG. 4A illustrates example wireless data according to the principles of the present disclosure.

FIG. 4B illustrates an example hard disk drive data package according to the principles of the present disclosure.

FIG. 5 illustrates an example method of operating a wireless mobile hard disk drive according to the principles of the present disclosure.

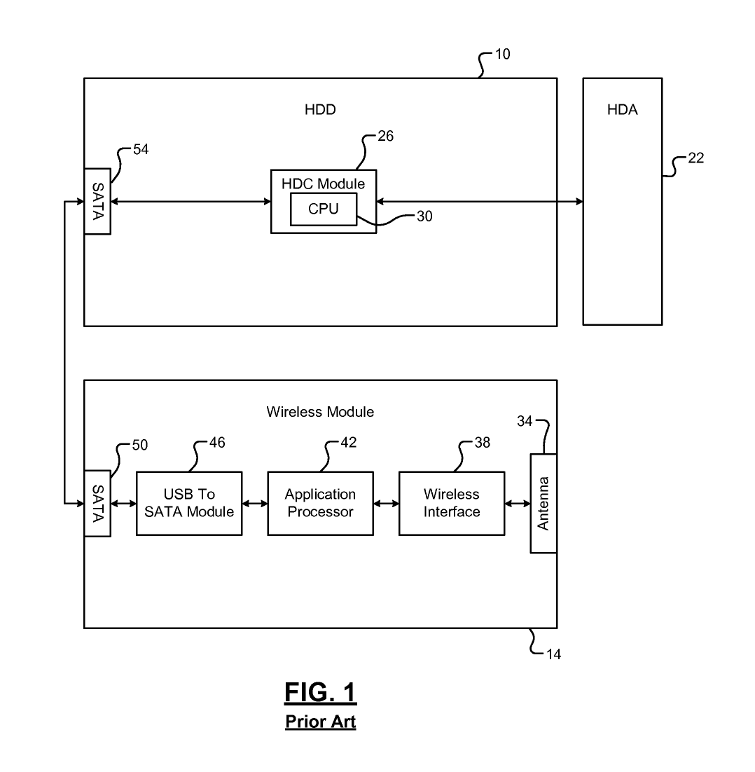

In the drawings, reference numbers may be reused to identify similar and/or identical elements.

### DESCRIPTION

An electronic device such as, for example only, a laptop computer, a media player device, a smartphone, or a tablet computer may communicate wireless with a mobile hard disk drive (HDD). For example, the mobile HDD may be a wireless mobile HDD that includes a wireless communication interface (e.g., a WiFi interface and one or more antennas). Typically, an HDD includes a printed circuit board (PCB). The PCB includes various components of the HDD, including, but not limited to, memory (e.g., volatile and nonvolatile memory), a storage controller (e.g., a hard disk controller), communication interfaces (e.g., USB and SATA), and read/write channel components. The storage controller includes a first processor (e.g., a primary processor) for controlling writing of data to the HDD and reading of data from the HDD. The wireless mobile HDD may also include a battery or other power source.

A wireless mobile HDD also includes or interfaces with a second processor (e.g., a secondary processor). For example, the second processor may be located on a separate PCB within the HDD, or may be integrated with a separate device that communicates with the HDD via a wired or plug-in connection. The second processor controls wireless communication, and may be integrated with a wireless receiver and/or interface. The second processor may also interface with different volatile and nonvolatile memory than the memory on the PCB of the HDD. Accordingly, a wireless mobile HDD may require an additional processor, memory, and/or power source (e.g., a battery) to implement wireless communication functions.

A wireless mobile HDD according to the principles of the present disclosure includes a single processor that controls wireless communication and read/write functions of the HDD. For example, the PCB of the wireless mobile HDD may include the processor (e.g., in a storage controller of the HDD), a wireless communication interface and antenna, and volatile and nonvolatile memory. The processor interfaces with both the wireless communication interface and the HDD. For example, the wireless communication interface may comprise a wireless chip that implements a first set of protocols associated with transmitting and receiving data packets via a wireless communication medium (e.g., using the antenna). Conversely, the processor implements a second set of protocols associated with controlling and interfacing with the HDD, as well as configuring, controlling, and interfacing with the wireless communication interface.

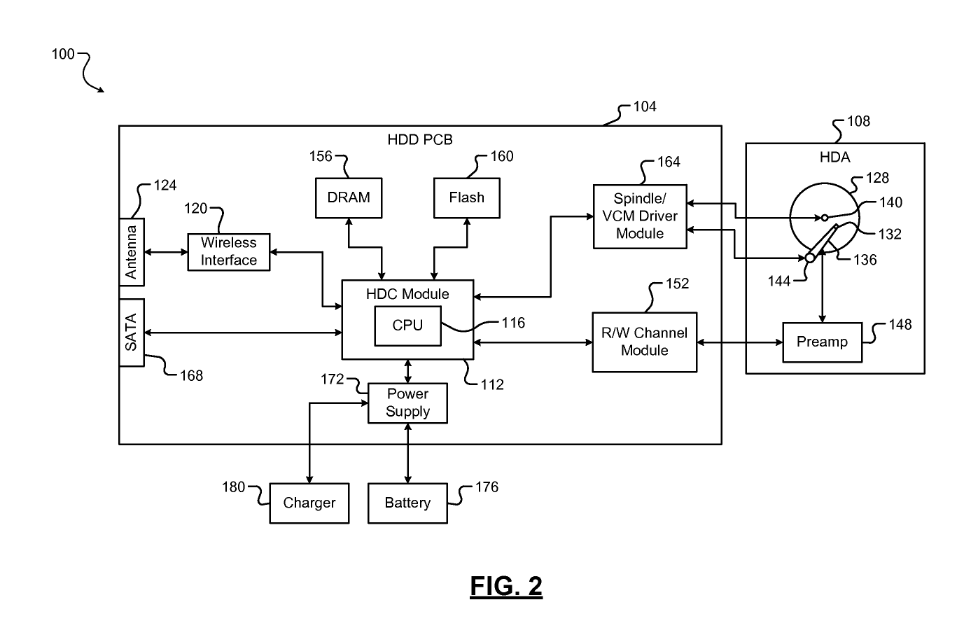

FIG. 2 shows a wireless mobile HDD 100. The HDD 100 includes an HDD PCB 104 and a hard disk assembly (HDA) 108. The PCB 104 includes a hard disk controller (HDC) module 112 that controls components of the HDA 108 and communicates with an external device (e.g., an electronic device such as a smartphone or a tablet computer; not shown) using a processor (e.g., CPU 116). For example, the CPU 116 communicates with the external device via a wireless interface 120 (e.g., a wireless chip) and antenna 124. For example only, the wireless interface 120 may be implemented according to IEEE standards 802.11-2012, 802.16-2009, and 802.20-2008, Bluetooth standards, or any other suitable wireless communication protocol. Although shown with one PCB 104, in other implementations the HDD 100 may include two or more PCBs. For example, the PCB 104 may include the HDC module 112 while another PCB (not shown) includes the wireless interface 120.

The HDA 108 may include a magnetic medium 128, such as one or more platters that store data, and a read/write device 132. The read/write device 132 may be arranged on an actuator arm 136 and may read and write data on the magnetic medium 128. Additionally, the HDA 108 includes a spindle motor 140 that rotates the magnetic medium 128 and a voice-coil motor (VCM) 144 that actuates the actuator arm 136. A preamplifier device 148 amplifies signals generated by the read/write device 132 during read operations and provides signals to the read/write device 132 during write operations. Further, although shown as a disk assembly including the magnetic medium 128, the HDA 108 may also be implemented as an SSD or other semiconductor hard drive. Accordingly, as used throughout the present disclosure, the term “HDA” may be considered to include other suitable hard drive types such as SSD hard drives.

The HDD PCB 104 further includes a read/write channel module (hereinafter, “read channel”) 152, volatile memory 156, nonvolatile memory 160, and spindle/VCM driver module 164, and a SATA connector 168. The read channel 152 processes data received from and transmitted to the preamplifier device 148. The HDC module 112 may receive data from the HDA 108, the read channel 152, volatile memory 156, the nonvolatile memory 160, the spindle/VCM driver module 164, and/or the wireless interface 120.

The CPU 116 may process the data, including encoding, decoding, filtering, and/or formatting. The processed data may be output to the HDA 108, the read channel 152, the volatile memory 156, the nonvolatile memory 160, the spindle/VCM driver module 164, and/or the wireless interface 120. Further, the CPU 116 controls wireless communication with the external device. For example, the CPU 116 receives data packets via the wireless interface 120 and writes the data packets to the HDA 108. Conversely, the CPU 116 reads the data packets from the HDA 108 and provides the data packets to the wireless interface 120 for transmission to the external device.

The HDC module 116 may use the volatile memory 156 and/or the nonvolatile memory 160 to store data related to the control and operation of the HDD 100. The volatile memory 156 may include semiconductor memory such DRAM, SRAM, DDR RAM, or any other suitable type of memory. The nonvolatile memory 160 may include any suitable type of semiconductor or solid-state memory, such as flash memory (including NAND and NOR flash memory), phase change memory, magnetic RAM, and multi-state memory, in which each memory cell has more than two states. The spindle/VCM driver module 914 controls the spindle motor 906 and the VCM 907.

The HDD PCB 104 includes a power supply 172 that provides power to the components of the HDD 100. For example, the power supply 172 may receive power from a rechargeable battery 176 and convert the power for distribution to the components of the HDD 100. The power supply 172 may also receive power from an external source such as a plug-in charger 180 for charging the battery 176 and/or providing power to the components of the HDD 100.

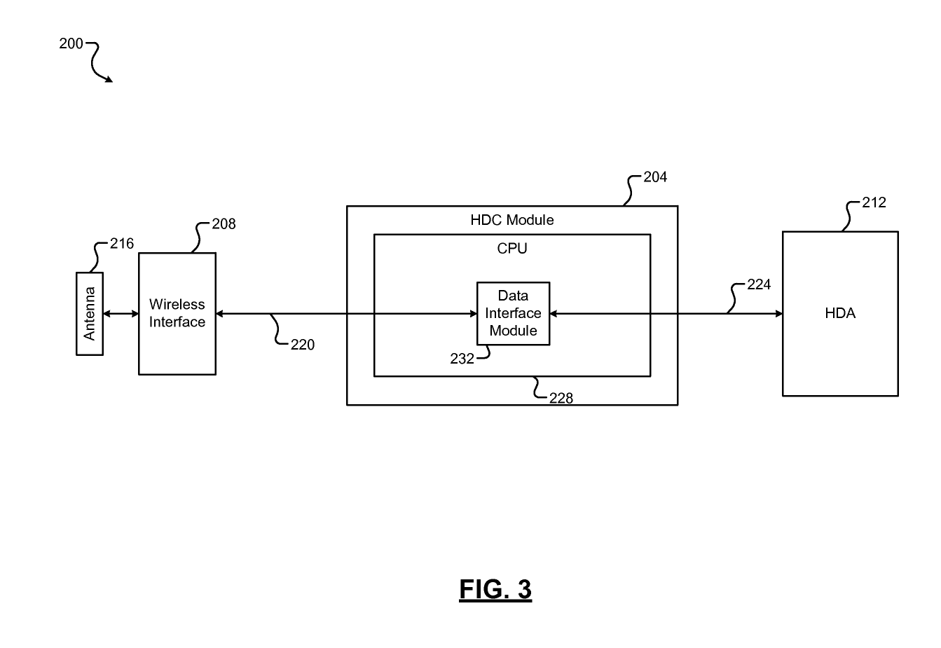

FIG. 3 shows a simplified block diagram of an example wireless mobile HDD 200 according to the principles of the present disclosure. The HDD 200 includes an HDC module 204, a wireless interface 208 (e.g., a wireless interface chip or module), and an HDA 212. The wireless interface 208 transmits and receives wireless data (e.g., WiFi data packets) using antenna 216. The wireless interface 208 provides the wireless data (e.g., in a wireless data format or package) 220 to the HDC module 204. For example, the wireless data 220 is retained in data packet form (i.e., packetized data including a header, data, etc.) for transmission from the wireless interface 208 to the HDC module 204. Conversely, the HDC module 204 transmits data to (and receives data from) the HDA 212 in a format suitable for storage in the HDA 212 (e.g., in a storage device data package such as HDD data package 224).

More specifically, instead of merely converting the wireless data 220 from packetized data to, for example, an HDD data format, the HDC module 204 retains the wireless data 220 in data packet form but packages the data in the HDD data package 224. For example, in a given data transaction, the wireless data 220 may include one or more data packets. The HDC module 204 retains the data packets as packetized data (e.g., including a header and other data packet fields) and generates the HDD data package 224 including the data packets. For example only, the HDC module 204 may append HDD related data (e.g., HDD control data, addressing information, etc.) to a beginning or end of the wireless data 220. Accordingly, when the HDD data package 224 is read from the HDA 212, the HDD data package 224 still includes the one or more data packets. The HDC module 204 removes the HDD related data from the HDD data package 224 to recover the wireless data 220, and provides the wireless data 220 to the wireless interface 208.

The wireless interface 208 implements a first set of protocols (e.g., a first protocol stack) associated with transmitting and receiving data packets via a wireless communication medium using the antenna 216. Conversely, the HDC module 204 includes a CPU 228 that implements a second set of protocols (e.g., a second protocol stack) associated with controlling and interfacing with the HDA 212 (e.g., encoding, decoding, filtering, and/or formatting data), as well as configuring, controlling, and/or interfacing with the wireless interface 208. For example only, the first set of protocols and the second set of protocols may be stored as firmware in non-volatile memory such as the non-volatile memory 160 shown in FIG. 2.

For example, the CPU 228 may include a data interface module 232. The data interface module 232 receives the wireless data 220 from the wireless interface 208 and provides the HDD data package 224 including the wireless data 220 to the HDA 212. For example only, the data interface module 232 packages the wireless data 220 into the HDD data package 224 by appending HDD related data to a beginning and/or an end of a group of one or more data packets comprising the wireless data 220. Conversely, the data interface module 232 receives the HDD data package 224 including the wireless data 220 from the HDA 212, and provides the wireless data 220 in the HDD data package 224 to the wireless interface 220. For example only, the data interface module 232 removes any appended HDD related data from the wireless data 220 and provides the wireless data 220 including only the one or more data packets to the wireless interface 208.

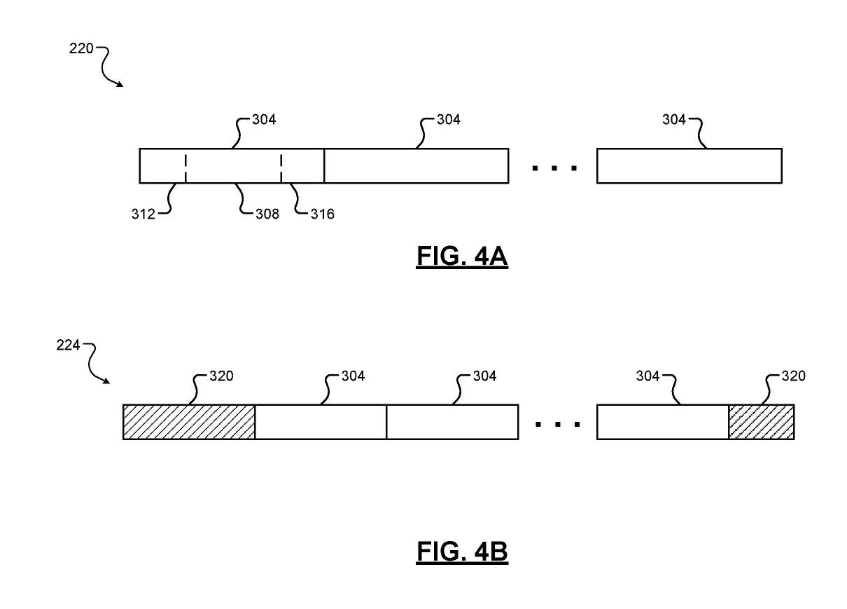

FIG. 4A shows an example of the wireless data 220. The wireless data 220 includes one or more data packets 304. Each of the data packets 304 includes, for example, data 308, a header 312, and an optional footer or trailer 316. For example only, the header 312 may include a sender IP address, a destination IP address, a packet number, a protocol indicator, etc. The data 308 includes user data (e.g., data to be stored in the HDA 212 and communicated for use by the external device. The trailer 316 may include error correction data and/or an indication of the end of the data packet 304. Accordingly, the wireless data 220 as shown in FIG. 3 includes a group of one or more of the data packets 304.

FIG. 4B shows an example of the HDD data package 224. The HDD data package 224 includes the data packets 304 of the wireless data 220. Further, the HDD data package 224 includes appended HDD related data 320 including, but not limited to, control data (e.g., data related to control of the HDA 212) and/or addressing data (e.g., data related to storing and/or retrieving the HDD data package 224). The CPU 228 appends the HDD related data 320 to the wireless data 220 for communicating the wireless data 220 to the HDA 212, and removes the HDD related data from the wireless data 220 for communicating the wireless data 220 to the wireless interface 208.

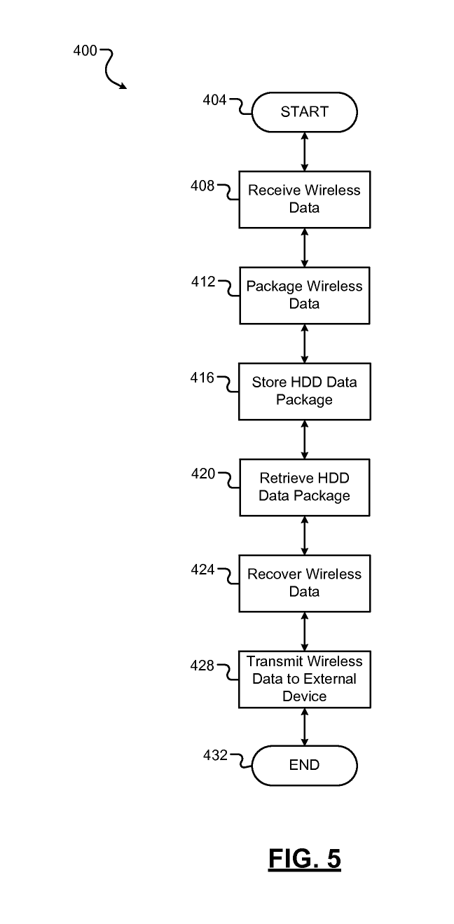

FIG. 5 illustrates an example method 400 of operating a wireless mobile HDD according to the principles of the present disclosure. The method 400 begins at 404. At 408, the method 400 receives wireless data at the HDD from an external device (e.g., via an antenna). At 412, the method 400 packages the wireless data into an HDD data package. At 416, the method 400 stores the HDD data package in a storage device (e.g., on a hard disk). At 420, the method 400 retrieves the HDD data package from the hard disk. At 424, the method 400 recovers the wireless data from the HDD data package. At 428, the method 400 transmits the wireless data from the HDD to the external device. The method 400 ends at 432.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

Further aspects of the present invention relate to one or more of the following clauses. A storage device includes a wireless interface and a processor. The wireless interface is configured to receive wireless data from a device external to the storage device. The wireless data includes at least one data packet configured according to a wireless communication protocol. The processor is configured to receive the wireless data including the at least one data packet from the wireless interface, generate a storage device data package including the wireless data, store, in a storage region of the storage device, the storage device data package including the wireless data, retrieve the storage device data package from the storage region, recover the wireless data from the storage device data package, and provide the wireless data to the wireless interface for transmission to the device external to the storage device.

In some implementations, the storage device includes a printed circuit board that includes the wireless interface and the processor. Or, the storage device includes a first printed circuit board that includes the wireless interface and a second printed circuit board that includes the processor. The wireless interface is configured to execute a first set of protocols associated with transmitting and receive the wireless data. The processor is configured to execute a second set of protocols associated with at least one of controlling the storage device, configuring the wireless interface, and controlling the wireless interface.

In other implementations, the storage device includes non-volatile memory configured to store firmware associated with the first set of protocols and the second set of protocols. Generating the storage device data package includes appending at least one of control data and addressing data to the wireless data. The at least one data packet includes data and a header, and the wireless data in the storage device data package stored in the storage region includes the at least one data packet. The wireless communication protocol includes at least one of IEEE standards 802.11-2012, 802.16-2009, and 802.20-2008, and a Bluetooth standard. The wireless interface includes a WiFi chip. The storage device includes a hard disk drive (HDD).

A method of operating a storage device includes receiving, using a wireless interface located in the storage device, wireless data from a device external to the storage device, wherein the wireless data includes at least one data packet configured according to a wireless communication protocol, and, using a processor located in the storage device, receiving the wireless data including the at least one data packet from the wireless interface, generating a storage device data package including the wireless data, storing, in a storage region of the storage device, the storage device data package including the wireless data, retrieving the storage device data package from the storage region, recovering the wireless data from the storage device data package, and providing the wireless data to the wireless interface for transmission to the device external to the storage device.

What is claimed is:

1. A storage device, comprising:
a wireless interface configured to receive wireless data from a device external to the storage device, wherein the wireless data includes at least one data packet configured according to a wireless communication protocol; and
a processor configured to
i) receive the wireless data including the at least one data packet from the wireless interface,
ii) generate a storage device data package including the wireless data,
iii) store, in a storage region of the storage device, the storage device data package including the wireless data,
iv) retrieve the storage device data package from the storage region,
v) recover the wireless data from the storage device data package, and
vi) provide the wireless data to the wireless interface for transmission to the device external to the storage device.

2. The storage device of claim 1, further comprising a printed circuit board that includes i) the wireless interface, and ii) the processor.

3. The storage device of claim 1, further comprising:
a first printed circuit board that includes the wireless interface; and
a second printed circuit board that includes the processor.

4. The storage device of claim 1, wherein:
the wireless interface is configured to execute a first set of protocols associated with transmitting and receive the wireless data; and
the processor is configured to execute a second set of protocols associated with at least one of controlling the storage device, configuring the wireless interface, and controlling the wireless interface.

5. The storage device of claim 4, further comprising non-volatile memory configured to store firmware associated with the first set of protocols and the second set of protocols.

6. The storage device of claim 1, wherein generating the storage device data package includes appending at least one of control data and addressing data to the wireless data.

7. The storage device of claim 1, wherein i) the at least one data packet includes data and a header, and ii) the wireless data in the storage device data package stored in the storage region includes the at least one data packet.

8. The storage device of claim 1, wherein the wireless communication protocol includes at least one of IEEE standards 802.11-2012, 802.16-2009, and 802.20-2008, and a Bluetooth standard.

9. The storage device of claim 1, wherein the wireless interface includes a WiFi chip.

10. The storage device of claim 1, wherein the storage device includes a hard disk drive (HDD).

11. A method of operating a storage device, the method comprising:
receiving, using a wireless interface located in the storage device, wireless data from a device external to the storage device, wherein the wireless data includes at least one data packet configured according to a wireless communication protocol; and
using a processor located in the storage device,
i) receiving the wireless data including the at least one data packet from the wireless interface,
ii) generating a storage device data package including the wireless data,
iii) storing, in a storage region of the storage device, the storage device data package including the wireless data,
iv) retrieving the storage device data package from the storage region,
v) recovering the wireless data from the storage device data package, and
vi) providing the wireless data to the wireless interface for transmission to the device external to the storage device.

12. The method of claim 10, further comprising arranging the wireless interface and the processor on a printed circuit board in the storage device.

13. The method of claim 10, further comprising:
arranging the wireless interface on a first printed circuit board in the storage device; and
arranging the processor on a second printed circuit board in the storage device.

14. The method of claim 10, wherein:
executing, using the wireless interface, a first set of protocols associated with transmitting and receive the wireless data; and
executing, using the processor, a second set of protocols associated with at least one of controlling the storage device, configuring the wireless interface, and controlling the wireless interface.

15. The method of claim 14, further comprising storing, in non-volatile memory located in the storage device, firmware associated with the first set of protocols and the second set of protocols.

16. The method of claim 10, wherein generating the storage device data package includes appending at least one of control data and addressing data to the wireless data.

17. The method of claim 10, wherein i) the at least one data packet includes data and a header, and ii) the wireless data in the storage device data package stored in the storage region includes the at least one data packet.

18. The method of claim 10, wherein the wireless communication protocol includes at least one of IEEE standards 802.11-2012, 802.16-2009, and 802.20-2008, and a Bluetooth standard.

19. The method of claim 10, wherein the wireless interface includes a WiFi chip.

20. The method of claim 10, wherein the storage device includes a hard disk drive (HDD).
